(19) United States
(12) Patent Application Publication
(10) Pub. No.: US 2017/0013865 A1
(43) Pub. Date: Jan. 19, 2017

(54) METHOD OF PREPARING A FOOD PRODUCT

(71) Applicant: Rick Valentine, Indianola, IA (US)

(72) Inventor: Rick Valentine, Indianola, IA (US)

(21) Appl. No.: 15/211,909

(22) Filed: Jul. 15, 2016

Related U.S. Application Data
(60) Provisional application No. 62/192,636, filed on Jul. 15, 2015.

(51) Int. Cl. A23L 5/10; G06Q 50/12; B65D 81/34; B65B 63/08; A23L 3/36; B65B 31/00

(52) U.S. Cl. CPC A23L 5/13; A23L 3/36; B65B 31/00; B65D 81/3415; B65B 63/08; G06Q 50/12; A23V 2002/00

(57) ABSTRACT

The present invention relates to a method of preparing a food product for commercial distribution and consumption by consumers. The method involves placing one or more raw food products into a vacuum pack bag and vacuum packing it. The vacuum pack bag is placed into a circulator that has an insulated tank, a pump, a heated coil, and a thermostat. The raw food product is cooked to a predetermined temperature and then removed and stabilized while still in the vacuum pack bag. The now cooked food product is then prepared for sale to a consumer. Though in some embodiments the cooked food product is prepared at a second location, such as by a caterer that reheats the product to a desired temperature. The same vacuum pack bag is used throughout the inventive method.

### CROSS-REFERENCE TO RELATED APPLICATIONS

This application claims priority to Provisional Application U.S. Ser. No. 62/192,636 filed on Jul. 15, 2015, of which is herein incorporated by reference in its entirety.

### BACKGROUND OF THE INVENTION

This invention is directed to a method of preparing a food product and more particularly a method of preparing a food product for commercial distribution and consumption by consumers that is safe and easy.

Preparation of food products for commercial distribution and consumption by consumers is well-known. Currently, the primary method known in the art is to cook a food item, such as a raw meat product like chicken in an open air environment, stabilize the cooked meat product, freeze the cooked meat product, and then package the frozen cooked meat product for sale to a consumer for consumption after reheating. Other methods of preparation have not been explored given the high costs that are associated with necessary pathogen testing.

This existing method, however, has a number of deficiencies. The stabilization process, for instance risks exposure of the product to a variety of contaminants, such as listeria and Clostridium botulinum, which can be fatal. Also, the risk of cross-contamination eliminates the ability to prepare different products using the same equipment, for example, preparing fish where chicken is prepared.

Other deficiencies relate to the reheating process, whereby the food item almost always loses some of its nutritional value and taste, which in turn lowers the commercial value of the product as the consumer is less willing to purchase a product that does not taste as good as if the consumer cooked the product themselves. Similarly, the need for additives and preservatives can diminish the taste of the product or turn away customers who are attempting to engage in clean eating by eating from clean-label products, i.e. those products that do not have additives or preservatives.

Another deficiency associated with this method is the need for grease traps and hoods. The use of grease traps and hoods not only require substantial maintenance, but also pose as a potential workplace hazard and also cause harm to the environment due to cleaning and disposing of the waste associated with these devices.

In another commercial distribution environment, the restaurant industry, preparing safe high quality food items suffers from many of the same deficiencies as the previous method of preparing a food product for commercial distribution. Additionally, the restaurant industry requires food preparation that is not only time consuming and labor intensive, but also requires substantial training and experience as a variety of food products must be prepared by a single person or team. As such, quality and safety of the food product served is dependent upon the skill of the chef, and at times in remote locations with limited equipment available from a normal kitchen. Also, restaurants require consistent preparation of products to particular temperatures set by groups of consumers. In this process of distribution, food is often wasted due to mistakes, while requiring a wide variety of equipment.

Thus it is a primary objective of this invention to provide a method of preparing a food product for commercial distribution and consumption by consumers that improves upon the art.

Another objective of this invention is to provide a method of preparing a food product for commercial distribution and consumption by consumers that provides a clean label food product.

Yet another objective of this invention is to provide a method of preparing a food product for commercial distribution and consumption by consumers that provides a high quality food product and maintains natural flavor.

Another objective of this invention is to provide a method of preparing a food product for commercial distribution and consumption by consumers that is prepared in an environmentally friendly manner, such as the exclusion of grease traps and hoods.

Yet another objective of this invention is to provide a method of preparing a food product for commercial distribution and consumption by consumers that uses the same vacuum pack bag for cooking as packaging.

Another objective of this invention is to provide a method of preparing a food product for commercial distribution and consumption by consumers that permits cooking of multiple food products on the same equipment without risk of cross-contamination.

Yet another objective of this invention is to provide a method of preparing a food product for commercial distribution and consumption by consumers that is easy to use by consumers and industry.

Another objective of this invention is to provide a method of preparing a food product for commercial distribution and consumption by consumers that requires minimal consumer preparation.

These and other objectives, features, and advantages of the invention will become apparent from the specification and claims.

### BRIEF DESCRIPTION OF THE DRAWINGS

FIG. 1 is a block diagram of an example system using a method of preparing a food product for commercial distribution and consumption by consumers; and

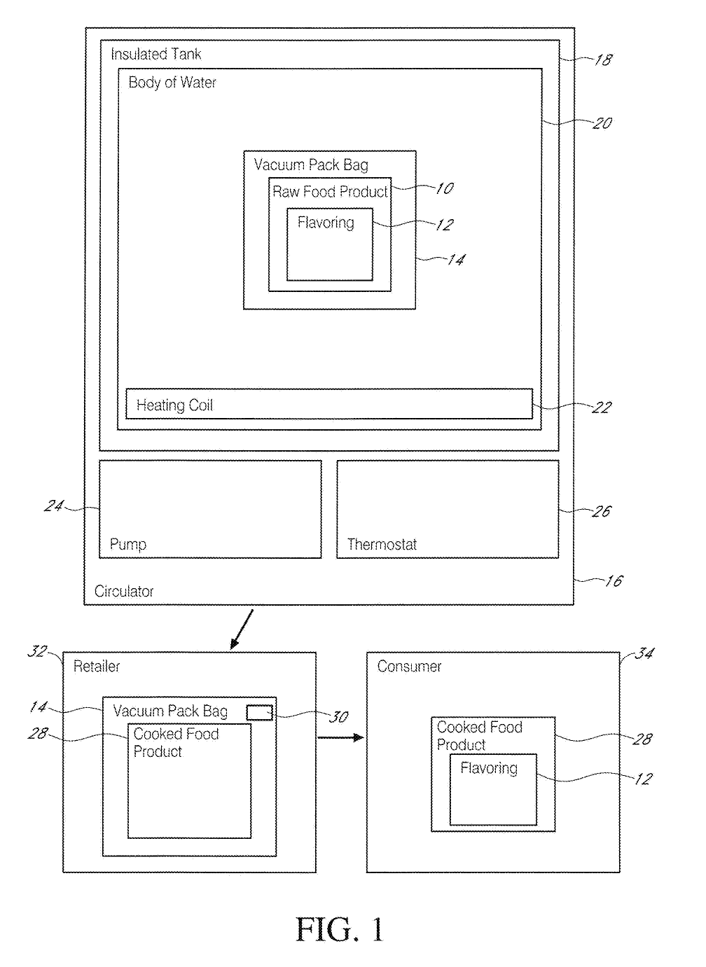

FIG. 2 is a flowchart of a method of preparing a food product for commercial distribution and consumption by consumers.

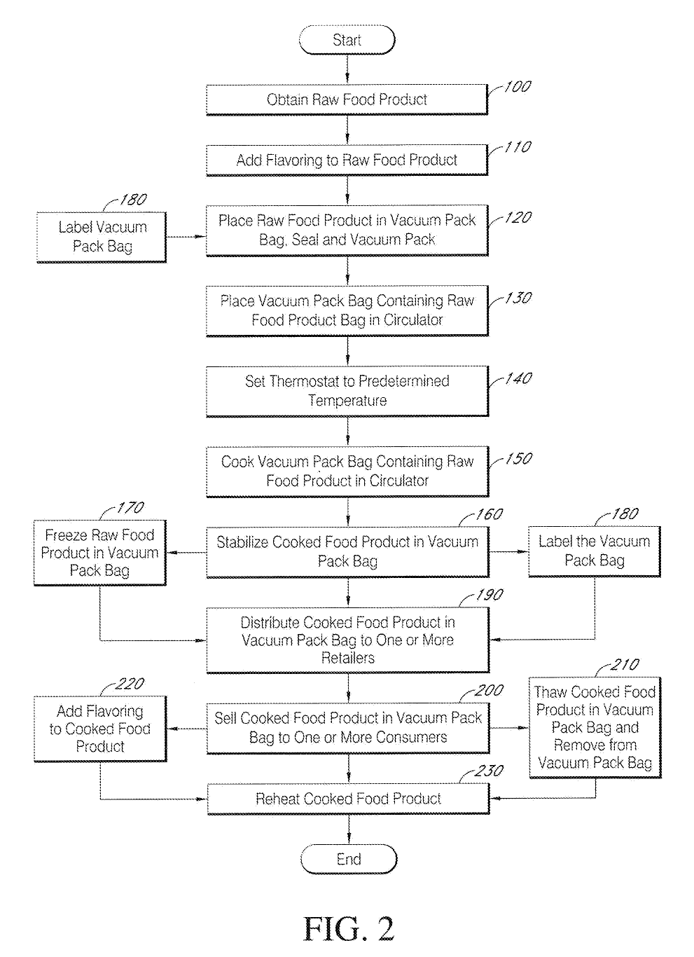

### SUMMARY OF THE INVENTION

In general, the present invention relates to a method of preparing a food product for commercial distribution and consumption by consumers. The method involves placing one or more raw food products into a vacuum pack bag and vacuum packing it. The vacuum pack bag is placed into a circulator that has an insulated tank, a pump, a heated coil, and a thermostat. The raw food product is cooked to a predetermined temperature and then removed and stabilized while still in the vacuum pack bag. The now cooked food product is then prepared for sale to a consumer. Though, in some embodiments, the cooked food product is prepared at a second location, such as by a caterer that reheats the product to a desired temperature. The same vacuum pack bag is used throughout the inventive method.

### DETAILED DESCRIPTION OF THE PREFERRED EMBODIMENTS

A method of preparing a food product for commercial distribution and consumption by consumers includes a first step 100 of obtaining one or more raw food product 10. The raw food product 10 is of any type, including meats, such as beef, pork, poultry, fish, and the like, and non-meats, such as vegetables and pastas, or any other edible food. The raw food product 10 is obtained in any conventional manner.

Next, at step 110, the raw food product 10 is seasoned and flavored with a flavoring 12, such as salt, pepper, and any other type of spice, adding a rub, marinade, or sauce, or brining. In one embodiment of the present invention, the flavoring 12 does not contain any additives or preservatives so that the food product 10 maintains a clean label.

Once seasoned at step 110, the raw food product 10 is placed inside a vacuum pack bag 14, sealed, and vacuum packed at step 120. The vacuum pack bag 14 in one exemplary embodiment is airtight and capable of having all of the oxygen removed. Additionally, the vacuum pack bag 14 in one embodiment is configured to be boiled without the vacuum pack bag 14 being ruptured. In other embodiments, the vacuum pack bag 14 can withstand temperatures above the boiling point of water without rupturing. At step 120, more than one raw food product 10 may be in the vacuum pack bag 14 prior to sealing and vacuum packing and the raw food product 10 may not be of the same type or variety, e.g. the vacuum pack bag 14 can contain beef and vegetables.

At step 130 one or more vacuum pack bag 14 containing the one or more raw food product 10 is placed in a circulator 16. The circulator 16 includes an insulated tank 18 that has a body of water 20. In order to produce commercial volumes for distribution, the insulated tank 18 holds at least fifty gallons of water in one embodiment because this allows large quantities of vacuum pack bags 14 containing raw food product 10 to be placed in a circulator 16. In another embodiment, the insulated tank 18 holds at least one hundred gallons of water to permit even greater efficiency. A heating coil 22 and a pump 24 are inserted into the body of water 20. Connected to the heating coil 22 is a thermostat 26 that is in communication with the heating coil 22 and the thermostat 26 is configured to set the heating coil 22 to a desired temperature.

At step 140 the thermostat 26 is set to a predetermined temperature. In one embodiment, the predetermined temperature is the internal temperature necessary to kill all pathogens, bacteria, and the like set by the Food and Drug Administration for the one or more raw food product 10 contained in the vacuum pack bag 14. This in turn causes the heating coil 22 to heat the body of water 20 to the predetermined temperature. In one example of the present invention, the thermostat 26 is set to the predetermined temperature and the body of water 20 is adjusted to the predetermined temperature prior to placing the vacuum pack bag 14 containing the one or more raw food product 10 into the circulator 16 to prevent possible overcooking of the raw food product 10 in the event the body of water 20 is too hot.

At step 150, the vacuum pack bag 14 containing the one or more raw food product 10 is left in the body of water 20 of the circulator 16 until the internal temperature of the raw food product 10 reaches the predetermined temperature, at which point the raw food product 10 is a cooked food product 28. In one embodiment of the inventive method, the duration allowed to elapse during step 150 is a predetermined amount of time.

At step 160 the cooked food product 28 is removed from the circulator 16 in the vacuum pack bag 14. After being removed at step 160, the cooked food product 28 contained in the vacuum pack bag 14 is also thermally stabilized at step 160. In one embodiment of the inventive method, the cooked food product 28 contained in the vacuum pack bag 14 is frozen at step 170 after being removed and stabilized at step 160.

In contrast to known methods, the continuous enclosure in the vacuum pack bag 14 provides the unique benefit of eliminating the risk of exposure to contaminants. Additionally, the combination of the vacuum pack bags 14 and the adjustable thermostat 26 permits the circulator 16 to be used to prepare a variety of raw food products 10 without the risk of cross contamination. Vacuum pack bags 14 and cooking with a circulator 16 eliminate the need for grease traps and hoods, which provide the unique benefit of eliminating the laborious maintenance of these devices and their environmentally harmful nature to use and maintain.

In one example of the present invention, the vacuum pack bag 14 is adhered with a label 30 at step 180. The label 30 can contain nutritional information, advertising information, and sales information such as pricing and a barcode. In one embodiment, the label 30 is preprinted on the vacuum pack bag 14 prior to step 120. In another embodiment, the label 30 is adhered to the vacuum pack bag 14 after stabilization at step 160. In yet another embodiment, the label 30 is adhered after freezing at step 170. In an alternative embodiment, the vacuum pack bag 14 containing the cooked food product 28 are not labeled directly but placed in a second bag that contains the label 30 and sealed at step 180.

Next at step 190, one or more cooked food product 28 contained in the vacuum pack bag 14 is distributed to one or more retailer 32 to be purchased by one or more consumer 34 at step 200. After distribution at step 190 the cooked food product 28 contained in the vacuum pack bag 14 is purchased by one or more consumer 34.

After being purchased by the consumer 34 at step 200 and the consumer 34 is ready to prepare the cooked food product 28 for consumption the cooked food product 28 is thawed and removed from the vacuum pack bag 14 at step 210. In some embodiments, thawing at step 210 will not be necessary. In one embodiment, additional flavoring 12 is added to the cooked food product 28 at step 220. At this point, the cooked food product 28 has been cooked initially in a closed environment, which maintains a high quality product that retains the natural flavor, nutritional value, and clean label status.

Finally, at step 230, the cooked food product 28 is reheated and served. For example, the reheating step 230 can involve first searing a piece of thawed meat on a grill and then warming on a grill, stove top, or oven to a desired serving temperature. Alternatively, the reheating step 230 can involve placing the cooked food product 28 in a rethermalizer which completely eliminates the need for a grease trap and a hood. The reheating step 230 requires only a few minutes to bring the cooked food product 28 to a safe serving temperature.

In one exemplary embodiment, steps 100 through 170 are carried out in a catering or food vendor, such as truck vendors, scenario. In this scenario, the raw food product 10 is prepared at a first location, stabilized 160, and frozen 170 if desired. The cooked food product 28, which is still in the vacuum pack bag 14 is transported to a second location that is remote to the first location, i.e. is located in a different geographical location that is not quickly accessible from the first location, for instance a banquet hall or other venue that is at a different location from where the circulator 16 is located, such as a different building or city. The cooked food product 28 is removed from the vacuum pack bag 14 and then flavored further 220, if desired, and reheated 230 to the desired temperature prior to being served to the consumer 34. This in turn provides a safe, quick, and easy method that involves little waste that improves the quality of the food, while limiting the amount of equipment needed to execute the dining experience.

Therefore, a method of preparing a food product for commercial distribution and consumption by consumers has been provided that provides a clean label food product, a high quality food product and maintains natural flavor, that is prepared in an environmentally friendly manner, such as the exclusion of grease traps and hoods, that uses the same vacuum pack bag for cooking as packaging, that permits cooking of multiple food products on the same equipment without risk of cross-contamination, that is easy to use by consumers and industry, that requires minimal consumer preparation, and improves upon the art.

From the above discussion and accompanying figures and claims it will be appreciated that the method of preparing a food product for commercial distribution and consumption by consumers offers many advantages over the prior art. It will be appreciated further by those skilled in the art that other various modification could be made to the method without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A method of preparing a food product for commercial distribution and consumption by consumers comprising:
providing a circulator having an insulated tank, a pump, a heated coil, and a thermostat;
obtaining a raw food product and vacuum packing it in a vacuum pack bag;
placing the raw food product within the vacuum pack bag into a body of water of the insulated tank;
cooking the raw food product within the vacuum pack bag to a predetermined temperature, such that a cooked food product is formed within the vacuum pack bag; and
selling the cooked food product within the vacuum pack bag to a consumer.

2. The method of claim 1 further comprising the step of flavoring the raw food product.

3. The method of claim 1 wherein the insulated tank holds at least fifty gallons of water.

4. The method of claim 1 wherein the insulated tank holds at least one hundred gallons of water.

5. The method of claim 1 further comprising the step of stabilizing the cooked food product within the vacuum pack bag.

6. The method of claim 1 further comprising the step of freezing the cooked food product within the vacuum pack bag.

7. The method of claim 1 further comprising the step of labeling the vacuum pack bag prior to placing the raw food product inside the vacuum pack bag.

8. The method of claim 5 further comprising the step of labeling the vacuum pack bag after stabilizing the cooked food product.

9. The method of claim 1 further comprising the step of setting the thermostat to a predetermined temperature.

10. The method of claim 9 wherein the predetermined temperature is the internal temperature necessary to kill all pathogens and bacteria in the raw food product.

11. The method of claim 1 further comprising the step of adding flavoring to the cooked food product.

12. The method of claim 1 further comprising the step of reheating the cooked food product to a desired temperature.

13. The method of claim 6 further comprising the step of thawing the frozen cooked food product.

14. A method of preparing a food product for commercial distribution and consumption by consumers comprising:
providing a circulator having an insulated tank, a pump, a heated coil, and a thermostat at a first location;
obtaining a raw food product and vacuum packing it in a vacuum pack bag;
placing the raw food product within the vacuum pack bag into a body of water within the insulated tank;
cooking the raw food product within the vacuum pack bag to a predetermined temperature, such that a cooked food product is formed within the vacuum pack bag;
stabilizing the cooked food product within the vacuum pack bag at the first location; and
reheating the cooked food product at a second location that is remote from the first location.

15. The method of claim 14 further comprising the step of adding flavoring to the cooked food portion at the second location.

16. The method of claim 15 further comprising the step of serving the cooked food product to a consumer at the second location.
